(19) United States
(12) Patent Application Publication
(10) Pub. No.: US 2016/0355259 A1
(43) Pub. Date: Dec. 8, 2016

(54) Hardpoint Strain Reliefs

(71) Applicant: Google Inc., Mountain View, CA (US)

(72) Inventors: Damon Vander Lind, Mountain View, CA (US); Gregor Boone Cadman, Mountain View, CA (US)

(21) Appl. No.: 15/171,984

(22) Filed: Jun. 2, 2016

Related U.S. Application Data
(60) Provisional application No. 62/170,464, filed on Jun. 3, 2015.

(51) Int. Cl. B64D 1/08; F03D 9/32; F03D 9/00; B64C 39/02

(52) U.S. Cl. CPC B64D 1/08; B64C 39/024; F03D 9/32; F03D 9/003; B64C 31/06

(57) ABSTRACT

A hardpoint relief pad is described and includes a base surface, a hardpoint overlay, and a first stress relief area. The base surface is configured to conform to and be fixedly attached to an interior surface of an aerial vehicle wing. The hardpoint overlay protrudes above adjacent areas of the hardpoint relief pad and is adapted to conform to a hardpoint. The hardpoint protrudes from the interior surface of the wing and is configured to carry a load fixed to the hardpoint. The hardpoint overlay includes an oculus that is configured to allow the load to be fixed to the hardpoint through the hardpoint overlay. The first stress relief area protrudes above adjacent areas of the hardpoint relief pad and also forms a hollow cavity between the first stress relief area and the interior surface of the wing.

### CROSS-REFERENCE TO RELATED APPLICATION

This application claims the benefit of U.S. Provisional Application No. 62/170,464, filed Jun. 3, 2015, which is explicitly incorporated by reference herein in its entirety.

### BACKGROUND

Unless otherwise indicated herein, the materials described in this section are not prior art to the claims in this application and are not admitted to be prior art by inclusion in this section.

Aerial vehicles may be composed of multiple separate components which are attached to each other via various attachment means. Preferably, an attachment means may be a structure that is robust and lightweight in order to allow the aerial vehicle to expend less energy during flight.

### SUMMARY

The present application discloses implementations that relate to devices, systems and methods that may include a hardpoint relief pad as part of an airborne wind turbine system. Devices described herein may include at least a first stress relief area that is designed to deform in order to help relieve strain when a load is applied to a hardpoint of an aerial vehicle wing. In some embodiments, the stress relief area(s) may be integrated into an interior surface of the wing. For example, a first stress relief area may be laminated into the interior surface of the wing. The stress relief area(s) may form a hollow cavity between the stress relief area(s) and the interior surface of the wing.

In at least one embodiment, a hardpoint relief pad is described. The hardpoint relief pad includes a base surface, a hardpoint overlay, and a first stress relief area. The base surface is configured to conform to and be fixedly attached to an interior surface of an aerial vehicle wing. The hardpoint overlay protrudes above adjacent areas of the hardpoint relief pad and is adapted to conform to a hardpoint. The hardpoint protrudes from the interior surface of the wing and is configured to carry a load fixed to the hardpoint. The hardpoint overlay includes an oculus that is configured to allow the load to be fixed to the hardpoint through the hardpoint overlay. The first stress relief area protrudes above adjacent areas of the hardpoint relief pad and also forms a hollow cavity between the first stress relief area and the interior surface of the wing. The first stress relief area is configured to deform in one or more axes when stress is applied to the hardpoint via the load.

In another embodiment, an aerial vehicle wing is described. The aerial vehicle wing includes a hardpoint and a first stress relief area. The hardpoint protrudes from an interior surface of the aerial vehicle wing and is configured to carry a load that is fixed to the hardpoint. The first stress relief area is integrated into and forms a hollow cavity within the interior surface of the wing. The first stress relief area protrudes above adjacent areas of the interior surface of the wing and is located a first distance from the hardpoint. The first stress relief area is configured to deform in one or more axes when stress is applied to the hardpoint via the load.

In yet another embodiment, an aerial vehicle is described. The aerial vehicle includes a pylon, a tail boom, a first hardpoint relief pad and a second hardpoint relief pad. The pylon is fixedly attached to a first hardpoint that protrudes from an interior surface of a wing of the aerial vehicle. The tail boom is fixedly attached to a second hardpoint that also protrudes from the interior surface of the wing. The first hardpoint relief pad corresponds to the first hardpoint and the second hardpoint relief pad corresponds to the second hardpoint. The first and the second hardpoint relief pad each include a base surface, a hardpoint overlay and a first stress relief area. Each base surface is configured to conform o and be fixedly attached to the interior surface of the wing. Each hardpoint overlay protrudes above adjacent areas of the hardpoint relief pad and is adapted to conform to at least one of the first and the second hardpoints. Each hardpoint overlay includes an oculus that is configured to allow the pylon or the tail boom to be fixed to the first or the second hardpoint through the hardpoint overlay. Each first stress relief area protrudes above adjacent areas of the hardpoint relief pad and also forms a hollow cavity between the first stress relief area and the interior surface of the wing. Further, each first stress relief area is configured to deform in one or more axes when stress is applied to the hardpoint via the pylon or tail boom.

These as well as other aspects, advantages, and alternatives will become apparent to those of ordinary skill in the art by reading the following detailed description, with reference where appropriate to the accompanying drawings.

### BRIEF DESCRIPTION OF THE FIGURES

FIG. 1 illustrates an airborne wind turbine, according to an example embodiment.

FIG. 2 is a simplified block diagram illustrating example components of the airborne wind turbine.

FIG. 3A is a perspective view of a hardpoint relief pad, according to an example embodiment.

FIG. 3B is a cross section of the hardpoint relief pad of FIG. 3A along a longitudinal axis, according to an example embodiment.

FIG. 3C is a cross section of the hardpoint relief pad of FIG. 3A along a transverse axis, according to an example embodiment.

FIG. 4 is a perspective view of a hardpoint relief pad, according to an example embodiment.

FIG. 5A is a perspective view of a hardpoint relief pad, according to an example embodiment.

FIG. 5B is a cross section view of the hardpoint relief pad of FIG. 5A, according to an example embodiment.

FIG. 6A is a perspective view of an aerial vehicle illustrating bottom interior wing surface hardpoint locations, according to an example embodiment.

FIG. 6B is a perspective view of an aerial vehicle illustrating hardpoint relief pad locations on bottom interior wing surface hardpoint locations, according to an example embodiment.

FIG. 6C is a cross section view of a wing of an aerial vehicle with a hardpoint relief pad, according to an example embodiment.

FIG. 6D is a perspective view of a portion of a wing of an aerial vehicle illustrating one of the FIG. 6B hardpoint relief pad locations on the bottom interior wing surface hardpoint location, according to an example embodiment.

FIG. 7 illustrates a wing that is coupled to a pylon, according to an example embodiment.

### DETAILED DESCRIPTION

Example methods and systems are described herein. Any example embodiment or feature described herein is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

Furthermore, the particular arrangements shown in the Figures should not be viewed as limiting. It should be understood that other embodiments might include more or less of each element shown in a given Figure. Further, some of the illustrated elements may be combined or omitted. Yet further, an example embodiment may include elements that are not illustrated in the Figures.

### I. Overview

Illustrative embodiments relate to aerial vehicles, which may be used in a wind energy system. An example of such an aerial vehicle is an energy kite, which may also be called an airborne wind turbine (“AWT”). In particular, illustrative embodiments may relate to or take the form of combined electrical and mechanical potted terminations that may be used in energy kite systems.

By way of background, an AWT may include an aerial vehicle that flies in a closed path, such as a substantially circular path, to convert kinetic wind energy to electrical energy. In an illustrative implementation, the aerial vehicle may be connected to a ground station via a tether. While tethered, the aerial vehicle can: (i) fly at a range of elevations and substantially along the path, and return to the ground, and (ii) transmit electrical energy to the ground station via the tether. (In some implementations, the ground station may transmit electricity to the aerial vehicle for take-off and/or landing.)

In an AWT, an aerial vehicle may rest in and/or on a ground station (or perch) when the wind is not conducive to power generation. When the wind is conducive to power generation, such as when a wind speed may be 3.5 meters per second (m/s) at an altitude of 200 meters (m), the ground station may deploy (or launch) the aerial vehicle. In addition, when the aerial vehicle is deployed and the wind is not conducive to power generation, the aerial vehicle may return to the ground station.

Moreover, in an AWT, an aerial vehicle may be configured for hover flight and crosswind flight. Crosswind flight may be used to travel in a motion, such as a substantially circular motion, and thus may be the primary technique that is used to generate electrical energy. Hover flight in turn may be used by the aerial vehicle to prepare and position itself for crosswind flight. In particular, the aerial vehicle could ascend to a location for crosswind flight based at least in part on hover flight. Further, the aerial vehicle could take-off and/or land via hover flight.

In hover flight, a span of a main wing of the aerial vehicle may be oriented substantially parallel to the ground, and one or more propellers of the aerial vehicle may cause the aerial vehicle to hover over the ground. In some implementations, the aerial vehicle may vertically ascend or descend in hover flight. Moreover, in crosswind flight, the aerial vehicle may be oriented, such that the aerial vehicle may be propelled by the wind substantially along a closed path, which as noted above, may convert kinetic wind energy to electrical energy. In some implementations, one or more rotors of the aerial vehicle may generate electrical energy by slowing down the incident wind.

For an AWT, energy may be expended in navigating the aerial vehicle to a position and altitude at which apparent wind can begin to cause the aerial vehicle to make substantially circular revolutions that cause dual purpose motor/generators of the AWT to produce energy. To generate energy efficiently, it is desirable to minimize the amount of energy expended to place the aerial vehicle into crosswind (energy generating) flight. One way to reduce this energy consumption is to reduce the weight of the aerial vehicle so that less energy is needed to put the aerial vehicle in position to begin crosswind flight. In one aspect, this may be accomplished by attempting to minimize the amount of structural framework required to support the aerial vehicle in flight.

However, during some operations, the aerial vehicle may experience instances of high strain, such as cyclic strain, which may compromise the integrity of the aerial vehicle if the structure is not properly designed and supported. For example, during crosswind flight the aerial vehicle may continuously make a turn toward a center of a circular path, which may cause the structural framework to experience instances of cyclic strain. As such, some form of reinforcing may be necessary to relieve the strain. However, reinforcing features that are designed to withstand strain, such as stiffening supports locally, may increase the mass of the wing, which may lead to less efficient energy generation. Additionally, installing additional materials may increase the cost to manufacture the wing because of additional material may be required and labor costs to install such supports may increase as well. Accordingly, it may be desirable to find a lightweight, low cost, reinforcement or relief that may lower the strain on the aerial vehicle.

The devices disclosed herein may allow aerial vehicle designs that include smaller and light structural elements while maintaining structural integrity during instances of high strain, making energy generation of the AWT more efficient. Pylons supporting the motor/generators of the AWT may be coupled to the main wing via one or more hardpoints. Additionally, the main wing may be coupled to a tail boom or other structure at one or more hardpoints. A hardpoint is a location of the main wing designed to carry an external or internal load, such as a load from a pylon or fuselage of an aerial vehicle. In some implementations, the hardpoint feature may include a hole in the skin of a wing of an aerial vehicle. The main wing may include an interior surface and one or more hardpoints protruding from the interior surface in order to connect one or more external features to the main wing of the aerial vehicle.

Within examples one or more stress relief areas may be designed or integrated into an interior surface of a wing of an aerial vehicle, near or around high stress points such as the hardpoints. One process to integrate such a stress relief area may include laminating the relief into the outer layer of the interior surface of the wing. Within other examples, a hardpoint relief pad may be installed with one or more stress relieving areas that are designed into the hardpoint relief pad itself. For example, the hardpoint relief pad may be manufactured with features including a hardpoint overlay and a first stress relief area, and then in another step the relief pad may be fixedly attached to the interior surface of the wing.

In some instances, such relief areas may be considered three-dimensional reliefs because the stress relief areas may define a hollow cavity between the stress relief area of the pad and the interior surface of the wing. While stress relief areas may vary in size, geometry and other specific features based upon a desired use or design, the stress relief areas may be configured to deform in one or more axes when stress is applied by way of an external load exerted on a hardpoint of the wing. Stress relief areas may help relieve imposed strain on hardpoints, may relieve strain on laminate surrounding the hardpoint, and may mitigate stress concentrations at the edges of the stress relief area.

In some embodiments, the hardpoint relief area may be configured to reduce cyclic strain on the wing at or near a hardpoint. As an example, a stress relief area of a hardpoint relief pad may include an elongated, hollow cavity along a longitudinal axis of the wing that is configured to flex along a transverse axis of the wing to relieve a load on the wing at and/or near the hardpoint. Providing at least one stress relief area, either integrated into the wing or manufactured into a hardpoint relief pad, may reduce cyclic strain on a wing when external loads, such as loads from a tail boom or pylon of an aerial vehicle, are applied to the wing via one or more hardpoints.

### II. Illustrative Systems

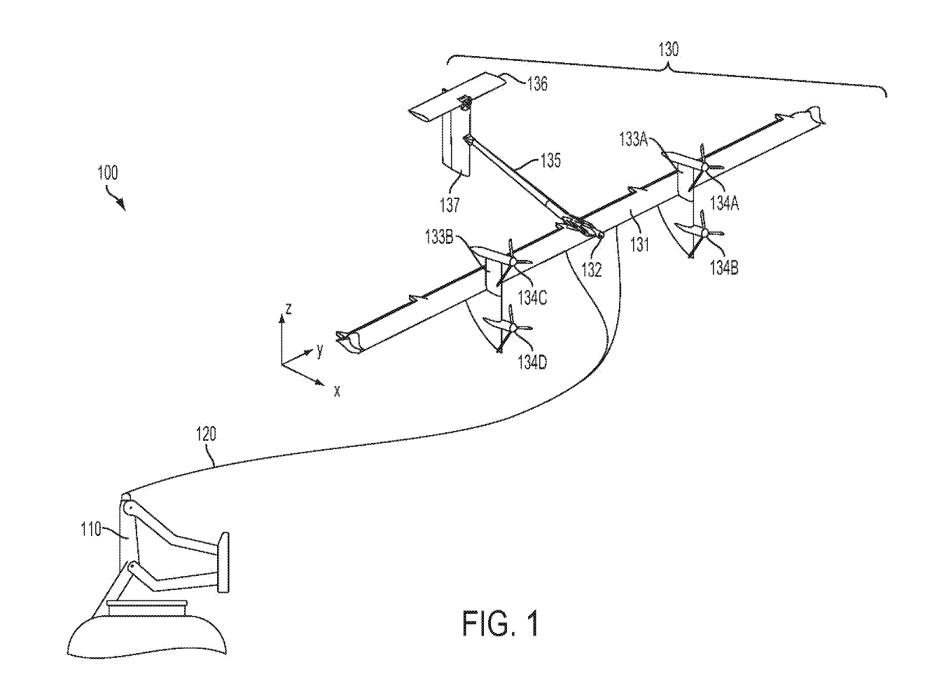

Referring now to the figures, FIG. 1 depicts an airborne wind turbine (“AWT”) 100, according to an example embodiment. The AWT 100 may include a ground station 110, a tether 120, and an aerial vehicle 130. As shown in FIG. 1, the aerial vehicle 130 may be connected to the tether 120, and the tether 120 may be connected to the ground station 110. The tether 120 may be attached to the ground station 110 at one location on the ground station 110, and attached to the aerial vehicle 130 at two locations on the aerial vehicle 130. However, in other examples, the tether 120 may be attached at multiple locations to any part of the ground station 110 or the aerial vehicle 130.

The ground station 110 may be used to hold or support the aerial vehicle 130 until the aerial vehicle 130 is in a flight or operational mode. The ground station 110 may also be configured to reposition the aerial vehicle 130 such that deploying the aerial vehicle 130 is possible. Further, the ground station 110 may be further configured to receive the aerial vehicle 130 during a landing. The ground station 110 may be formed of any material that can suitably keep the aerial vehicle 130 attached and/or anchored to the ground while in hover flight, crosswind flight, and other flight modes, such as forward flight (which may be referred to as airplane-like flight). In some implementations, a ground station 110 may be configured for use on land. However, a ground station 110 may also be implemented on a body of water, such as a lake, river, sea, or ocean. For example, a ground station could include or be arranged on a floating off-shore platform or a boat, among other possibilities. Further, a ground station 110 may be configured to remain stationary or to move relative to the ground or the surface of a body of water.

In addition, the ground station 110 may include one or more components (not shown), such as a winch, that may vary a length of the tether 120. For example, when the aerial vehicle 130 is deployed, the one or more components may be configured to pay out or reel out the tether 120. In some implementations, the one or more components may be configured to pay out or reel out the tether 120 to a predetermined length. As examples, the predetermined length could be equal to or less than a maximum length of the tether 120. Further, when the aerial vehicle 130 lands on the ground station 110, the one or more components may be configured to reel in the tether 120.

The tether 120 may transmit electrical energy generated by the aerial vehicle 130 to the ground station 110. In addition, the tether 120 may transmit electricity to the aerial vehicle 130 to power the aerial vehicle 130 for takeoff, landing, hover flight, or forward flight. The tether 120 may be constructed in any form and using any material that allows for the transmission, delivery, or harnessing of electrical energy generated by the aerial vehicle 130 or transmission of electricity to the aerial vehicle 130. The tether 120 may also be configured to withstand one or more forces of the aerial vehicle 130 when the aerial vehicle 130 is in a flight mode. For example, the tether 120 may include a core configured to withstand one or more forces of the aerial vehicle 130 when the aerial vehicle 130 is in hover flight, forward flight, or crosswind flight. The core may be constructed of high strength fibers. In some examples, the tether 120 may have a fixed length or a variable length. For instance, in at least one such example, the tether 120 may have a length of 140 meters.

The aerial vehicle 130 may include various types of devices, such as a kite, a helicopter, a wing, or an airplane, among other possibilities. The aerial vehicle 130 may be formed of solid structures of metal, plastic, polymers, or any material that allows for a high thrust-to-weight ratio and generation of electrical energy that may be used in utility applications. Additionally, the material used may allow for a lightning hardened, redundant or fault tolerant design, which may be capable of handling large or sudden shifts in wind speed and wind direction. Other materials may be possible to use as well.

As shown in FIG. 1, the aerial vehicle 130 may include a main wing 131, a front section 132, pylons 133A-B, rotors 134A-D, a tail boom 135, a tail wing 136, and a vertical stabilizer 137. Any of these components may be shaped in any form that allows for the use of lift to resist gravity or move the aerial vehicle 130 forward.

The main wing 131 may provide a primary lift for the aerial vehicle 130. The main wing 131 may be one or more rigid or flexible airfoils, and may include various control surfaces, such as winglets, flaps (e.g., Fowler flaps, Hoerner flaps, split flaps, and the like), rudders, elevators, spoilers, dive brakes, etc. The control surfaces may be operated to stabilize the aerial vehicle 130 and/or reduce drag on the aerial vehicle during hover flight, forward flight, and/or crosswind flight. In addition, in some examples, the control surfaces may be operated to increase drag and/or decrease lift on the aerial vehicle 130 during crosswind flight. In some examples, one or more control surfaces may be located on a leading edge of the main wing 131. Further, in some examples, one or more other control surfaces may be located on a trailing edge of the main wing 131.

The main wing 131 may be any suitable material for the aerial vehicle 130 to engage in hover flight, forward flight, and/or crosswind flight. For example, the main wing 131 may include carbon fiber and/or e-glass. Moreover, the main wing 131 may have a variety dimensions. For example, the main wing 131 may have one or more dimensions that correspond with a conventional wind turbine blade. As another example, the main wing 131 may have a span of 8 meters, an area of 4 meters squared, and an aspect ratio of 15. The front section 132 may include one or more components, such as a nose, to reduce drag on the aerial vehicle 130 during flight.

The pylons 133A-B may connect the rotors 134A-D to the main wing 131. In the example depicted in FIG. 1, the pylons 133A-B are arranged such that the rotors 134A and 134B are located on opposite sides of the main wing 131 and rotors 134C and 134D are also located on opposite sides of the main wing 131. The rotor 134C may also be located on an end of the main wing 131 opposite of the rotor 134A, and the rotor 134D may be located on an end of main wing 131 opposite of the rotor 134B.

The rotors 134A-D may be configured to drive one or more generators for the purpose of generating electrical energy, such when in a power generating mode. As shown in FIG. 1, the rotors 134A-D may each include one or more blades, such as three blades. The one or more rotor blades may rotate via interactions with the wind and could be used to drive the one or more generators. In addition, the rotors 134A-D may also be configured to provide a thrust to the aerial vehicle 130 during flight. As shown in FIG. 1, the rotors 134A-D may function as one or more propulsion units, such as a propeller. In some examples, the rotors 134A-D may be operated to increase drag on the aerial vehicle 130 during crosswind flight. Although the rotors 134A-D are depicted as four rotors in this example, in other examples the aerial vehicle 130 may include any number of rotors, such as less than four rotors or more than four rotors.

In a forward flight mode, the rotors 134A-D may be configured to generate a forward thrust substantially parallel to the tail boom 135. Based on the position of the rotors 134A-D relative to the main wing 131 depicted in FIG. 1, the rotors 134A-D may be configured to provide a maximum forward thrust for the aerial vehicle 130 when all of the rotors 134A-D are operating at full power. The rotors 134A-D may provide equal or about equal amounts of forward thrusts when the rotors 134A-D are operating at full power, and a net rotational force applied to the aerial vehicle by the rotors 134A-D may be zero.

The tail boom 135 may connect the main wing 131 to the tail wing 136. The tail boom 135 may have a variety of dimensions. For example, the tail boom 135 may have a length of 2 meters. Moreover, in some implementations, the tail boom 135 could take the form of a body and/or fuselage of the aerial vehicle 130. And in such implementations, the tail boom 135 may carry a payload. The tail boom 135 may connect the main wing 131 to the tail wing 136 and the vertical stabilizer 137.

The tail wing 136 and/or the vertical stabilizer 137 may be used to stabilize the aerial vehicle and/or reduce drag on the aerial vehicle 130 during hover flight, forward flight, and/or crosswind flight. For example, the tail wing 136 and/or the vertical stabilizer 137 may be used to maintain a pitch of the aerial vehicle 130 during hover flight, forward flight, and/or crosswind flight. In this example, the vertical stabilizer 137 is attached to the tail boom 135, and the tail wing 136 is located on top of the vertical stabilizer 137. The tail wing 136 may have a variety of dimensions. For example, the tail wing 136 may have a length of 2 meters. Moreover, in some examples, the tail wing 136 may have a surface area of 0.45 meters squared. Further, in some examples, the tail wing 136 may be located 1 meter above a center of mass of the aerial vehicle 130.

While the aerial vehicle 130 has been described above, it should be understood that the methods and systems described herein could involve any suitable aerial vehicle that is connected to a tether, such as the tether 120.

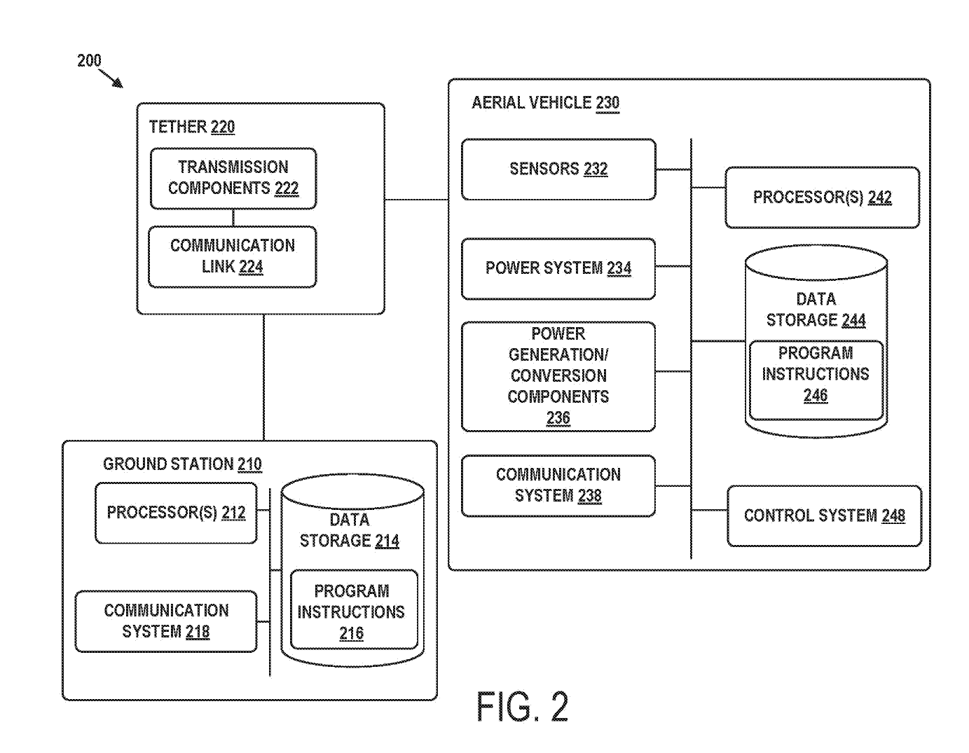

FIG. 2 is a simplified block diagram illustrating example components of an AWT 200. The AWT 100 may take the form of or be similar in form to the AWT 200. In particular, the AWT 200 includes a ground station 210, a tether 220, and an aerial vehicle 230. The ground station 110 may take the form of or be similar in form to the ground station 210, the tether 120 may take the form of or be similar in form to the tether 220, and the aerial vehicle 130 may take the form of or be similar in form to the aerial vehicle 230.

As shown in FIG. 2, the ground station 210 may include one or more processors 212, data storage 214, program instructions 216, and a communication system 218. A processor 212 may be a general-purpose processor or a special purpose processor (e.g., digital signal processors, application specific integrated circuits, etc.). The one or more processors 212 may be configured to execute computer-readable program instructions 216 that are stored in data storage 214 and are executable to provide at least part of the functionality described herein.

The data storage 214 may include or take the form of one or more computer-readable storage media that may be read or accessed by at least one processor 212. The one or more computer-readable storage media can include volatile or non-volatile storage components, such as optical, magnetic, organic or other memory or disc storage, which may be integrated in whole or in part with at least one of the one or more processors 212. In some embodiments, the data storage 214 may be implemented using a single physical device (e.g., one optical, magnetic, organic or other memory or disc storage unit), while in other embodiments the data storage 214 can be implemented using two or more physical devices.

As noted, the data storage 214 may include computer-readable program instructions 216 and perhaps additional data, such as diagnostic data of the ground station 210. As such, the data storage 214 may include program instructions to perform or facilitate some or all of the functionality described herein.

In a further respect, the ground station 210 may include the communication system 218. The communications system 218 may include one or more wireless interfaces or one or more wireline interfaces, which allow the ground station 210 to communicate via one or more networks. Such wireless interfaces may provide for communication under one or more wireless communication protocols, such as BLUETOOTH, Wi-Fi (e.g., an IEEE 802.11 protocol), Long-Term Evolution (LTE), WiMAX (e.g., an IEEE 802.16 standard), a radio-frequency ID (RFID) protocol, near-field communication (NFC), or other wireless communication protocols. Such wireline interfaces may include an Ethernet interface, a Universal Serial Bus (USB) interface, or a similar interface to communicate via a wire, a twisted pair of wires, a coaxial cable, an optical link, a fiber-optic link, or other physical connection to a wireline network. The ground station 210 may communicate with the aerial vehicle 230, other ground stations, or other entities (e.g., a command center) via the communication system 218.

In an example embodiment, the ground station 210 may include communication systems 218 that allows for both short-range communication and long-range communication. For example, the ground station 210 may be configured for short-range communications using BLUETOOTH and for long-range communications under a CDMA protocol. In such an embodiment, the ground station 210 may be configured to function as a “hot spot”, or as a gateway or proxy between a remote support device (e.g., the tether 220, the aerial vehicle 230, and other ground stations) and one or more data networks, such as a cellular network or the Internet. Configured as such, the ground station 210 may facilitate data communications that the remote support device would otherwise be unable to perform by itself

For example, the ground station 210 may provide a Wi-Fi connection to the remote device, and serve as a proxy or gateway to a cellular service provider's data network, which the ground station 210 might connect to under an LTE or a 3G protocol, for instance. The ground station 210 could also serve as a proxy or gateway to other ground stations or a command station, which the remote device might not be able to otherwise access.

Moreover, as shown in FIG. 2, the tether 220 may include transmission components 222 and a communication link 224. The transmission components 222 may be configured to transmit electrical energy from the aerial vehicle 230 to the ground station 210 or transmit electrical energy from the ground station 210 to the aerial vehicle 230. The transmission components 222 may take various different forms in different embodiments. For example, the transmission components 222 may include one or more conductors that are configured to transmit electricity. And in at least one such example, the one or more conductors may include aluminum or any other material that allows for the conduction of electric current. Moreover, in some implementations, the transmission components 222 may surround a core of the tether 220 (not shown).

The ground station 210 could communicate with the aerial vehicle 230 via the communication link 224. The communication link 224 may be bidirectional and may include one or more wired or wireless interfaces. Also, there could be one or more routers, switches, or other devices or networks making up at least a part of the communication link 224.

Further, as shown in FIG. 2, the aerial vehicle 230 may include one or more sensors 232, a power system 234, power generation/conversion components 236, a communication system 238, one or more processors 242, data storage 244, program instructions 246, and a control system 248.

The sensors 232 could include various different sensors in different embodiments. For example, the sensors 232 may include a global positioning system (GPS) receiver. The GPS receiver may be configured to provide data that is typical of GPS systems (which may be referred to as a global navigation satellite system (GNNS)), such as the GPS coordinates of the aerial vehicle 230. Such GPS data may be utilized by the AWT 200 to provide various functions described herein.

As another example, the sensors 232 may include one or more wind sensors, such as one or more pitot tubes. The one or more wind sensors may be configured to measure pressure or to detect apparent or relative wind. Such wind data may be utilized by the AWT 200 to provide various functions described herein.

Still as another example, the sensors 232 may include an inertial measurement unit (IMU). The IMU may include both an accelerometer and a gyroscope, which may be used together to determine the orientation or attitude of the aerial vehicle 230. In particular, the accelerometer can measure the orientation of the aerial vehicle 230 with respect to earth, while the gyroscope measures the rate of rotation around an axis, such as a centerline of the aerial vehicle 230. IMUs are commercially available in low-cost, low-power packages. For instance, the IMU may take the form of or include a miniaturized MicroElectroMechanical System (MEMS) or a NanoElectroMechanical System (NEMS). Other types of IMUs may also be utilized. The IMU may include other sensors, in addition to accelerometers and gyroscopes, which may help to better determine position. Two examples of such sensors are magnetometers and pressure sensors. Other examples are also possible.

While an accelerometer and gyroscope may be effective at determining the orientation of the aerial vehicle 230, errors in measurement may compound over time. However, an example aerial vehicle 230 may be able mitigate or reduce such errors by using a magnetometer to measure direction. One example of a magnetometer is a low-power, digital 3-axis magnetometer, which may be used to realize an orientation independent electronic compass for accurate heading information. However, other types of magnetometers may be utilized as well.

The aerial vehicle 230 may also include a pressure sensor or barometer, which can be used to determine the altitude of the aerial vehicle 230. Alternatively, other sensors, such as sonic altimeters or radar altimeters, can be used to provide an indication of altitude, which may help to improve the accuracy of or prevent drift of the IMU. In addition, the aerial vehicle 230 may include one or more load cells configured to detect forces distributed between a connection of the tether 220 to the aerial vehicle 230. The aerial vehicle 230 may include a thermometer or another sensor that senses air temperature as well.

As noted, the aerial vehicle 230 may include the power system 234. The power system 234 could take various different forms in different embodiments. For example, the power system 234 may include one or more batteries that provide power to the aerial vehicle 230. In some implementations, the one or more batteries may be rechargeable and each battery may be recharged via a wired connection between the battery and a power supply or via a wireless charging system, such as an inductive charging system that applies an external time-varying magnetic field to an internal battery or a charging system that uses energy collected from one or more solar panels.

As another example, the power system 234 may include one or more motors or engines for providing power to the aerial vehicle 230. In one embodiment, the power system 234 may provide power to the rotors 134A-D of the aerial vehicle 130, as shown and described in FIG. 1. In some implementations, the one or more motors or engines may be powered by a fuel, such as a hydrocarbon-based fuel. In such implementations, the fuel could be stored on the aerial vehicle 230 and delivered to the one or more motors or engines via one or more fluid conduits, such as piping. In some implementations, the power system 234 may be implemented in whole or in part on the ground station 210.

As noted, the aerial vehicle 230 may include the power generation/conversion components 236. The power generation/conversion components 236 could take various different forms in different embodiments. For example, the power generation/conversion components 236 may include one or more generators, such as high-speed, direct-drive generators. The one or more generators may be driven by one or more rotors or actuators, such as the rotors 134A-D as shown and described in FIG. 1. And in at least one such example, the one or more generators may operate at full rated power wind speeds of 11.5 meters per second at a capacity factor which may exceed 60 percent, and the one or more generators may generate electrical power from 40 kilowatts to 600 megawatts.

Moreover, the aerial vehicle 230 may include a communication system 238. The communication system 238 may take the form of or be similar in form to the communication system 218 of the ground station 210. The aerial vehicle 230 may communicate with the ground station 210, other aerial vehicles, or other entities (e.g., a command center) via the communication system 238.

In some implementations, the aerial vehicle 230 may be configured to function as a “hot spot” or as a gateway or proxy between a remote support device (e.g., the ground station 210, the tether 220, other aerial vehicles) and one or more data networks, such as cellular network or the Internet. Configured as such, the aerial vehicle 230 may facilitate data communications that the remote support device would otherwise be unable to perform by itself.

For example, the aerial vehicle 230 may provide a Wi-Fi connection to the remote device, and serve as a proxy or gateway to a cellular service provider's data network, which the aerial vehicle 230 might connect to under an LTE or a 3G protocol, for instance. The aerial vehicle 230 could also serve as a proxy or gateway to other aerial vehicles or a command station, which the remote device might not be able to otherwise access.

As noted, the aerial vehicle 230 may include the one or more processors 242, the program instructions 244, and the data storage 246. The one or more processors 242 can be configured to execute computer-readable program instructions 246 that are stored in the data storage 244 and are executable to provide at least part of the functionality described herein. The one or more processors 242 may take the form of or be similar in form to the one or more processors 212, the data storage 244 may take the form of or be similar in form to the data storage 214, and the program instructions 246 may take the form of or be similar in form to the program instructions 216.

Moreover, as noted, the aerial vehicle 230 may include the control system 248. In some implementations, the control system 248 may be configured to perform one or more functions described herein. The control system 248 may be implemented with mechanical systems or with hardware, firmware, or software. As one example, the control system 248 may take the form of program instructions stored on a non-transitory computer readable medium and a processor that executes the instructions. The control system 248 may be implemented in whole or in part on the aerial vehicle 230 or at least one entity remotely located from the aerial vehicle 230, such as the ground station 210.

Generally, the manner in which the control system 248 is implemented may vary, depending upon the particular embodiment.

### III. Illustrative Hardpoint Relief Embodiments

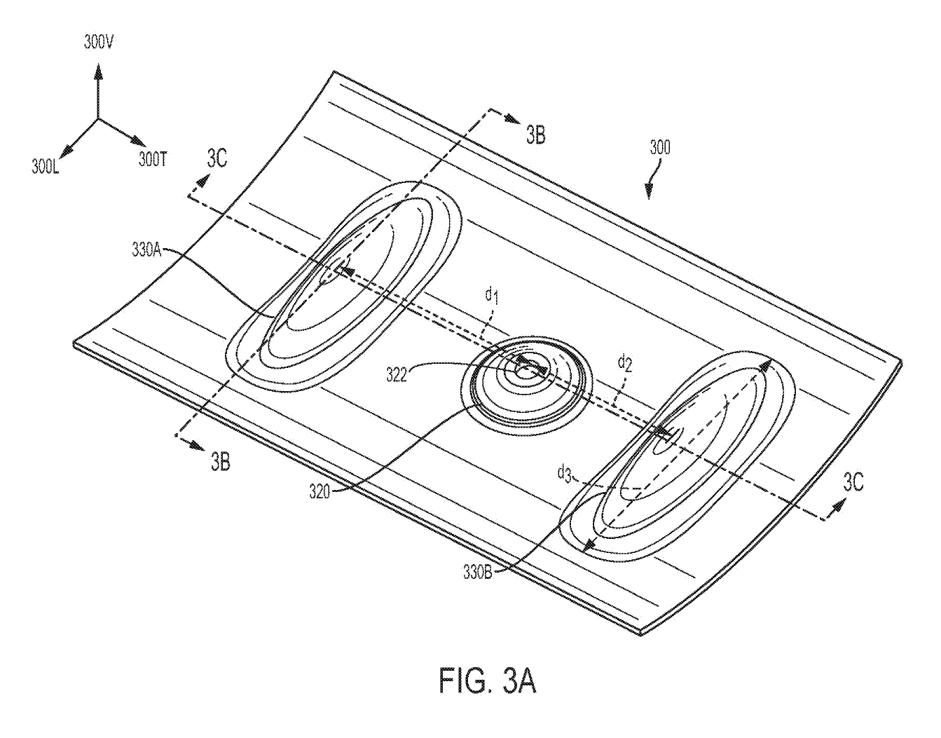

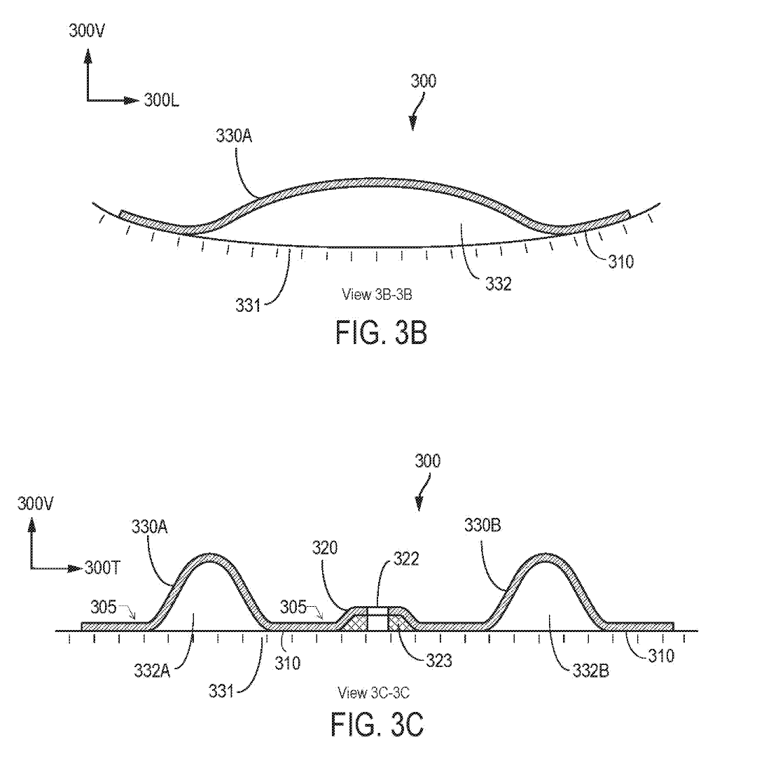

FIG. 3A is a perspective view of a hardpoint relief pad 300, according to some embodiments. FIG. 3A includes the hardpoint relief pad 300, a hardpoint overlay 320, an oculus 322, a first stress relief area 330A, a second stress relief area 330B (together one or more stress relief area(s) 330), a distance d1 (from the first stress relief area 330A to a center of the hardpoint overlay 320), a distance d2 (from the second stress relief area 330B to a center of the hardpoint overlay 320), and a distance d3 (a length of elongation of the second stress relief area 330B). Furthermore, FIG. 3A illustrates the locations of cross-section views 3B-3B and 3C-3C. Within examples provided, a longitudinal (or roll) axis 300L refers to an axis drawn through the body of the aerial vehicle approximately from tail to nose in the normal direction of flight, a transverse (or pitch) axis 300T refers to an axis that passes through the aerial vehicle approximately from wingtip to wingtip, and a vertical (or yaw) axis 300V refers to an axis approximately perpendicular to the wing of the aerial vehicle and directed between the top and bottom of the aircraft.

Within examples, the hardpoint overlay 320 may protrude above adjacent areas of the hardpoint relief pad 300. The adjacent areas may be areas of the hardpoint relief pad 300 that are adhered or otherwise attached to a wing of an aerial vehicle. Furthermore, the hardpoint overlay 320 may be adapted to conform to a hardpoint of the wing. For example, the hardpoint of the wing may have a rounded, dome like shape, that may protrude from the interior surface of the wing, and as such the hardpoint overlay 320 may have a similar shape designed to overlay on top of the hardpoint. The hardpoint overlay 320 may have other shapes in other examples based on the shape and/or design of the corresponding hardpoint. Although FIG. 3A illustrates the single hardpoint overlay 320, within other embodiments, the hardpoint relief pad may include more than one hardpoint overlays 320. Furthermore, the hardpoint overlay 320 may include the ocul s 322. The oculus 322 may correspond with a similar feature within the hardpoint on the wing such that the oculus 322 of the hardpoint overlay 320 is configured to allow a load to be fixed to the hardpoint through the hardpoint overlay 320. Within examples, the oculus 322 may be a circular opening in the center of the hardpoint overlay 320 and an attachment means, such as a bolt, rivet or other means, may pass through the oculus 322 in order to attach a component (a pylon) to the wing at the corresponding hardpoint.

As illustrated in FIG. 3A, the hardpoint relief pad 300 may include one or more stress relief area(s) 330, such as the first stress relief area 330A. Within examples, the hardpoint relief pad 300 may include the second stress relief area 330B, or any number of additional stress relief area(s) 330. Stress relief areas 330 may protrude above adjacent areas of the hardpoint relief pad 300. The adjacent areas may include areas of the hardpoint relief pad 300 that are adhered to the wing, areas between one or more stress relief area(s) 330, or between stress relief area(s) 330 and the hardpoint overlay 320. Furthermore, stress relief area(s) 330 may form a hollow cavity between the stress relief area(s) 330 and the interior surface of the wing of the aerial vehicle. The stress relief areas(s) 330 may be configured to deform in one or more axes when stress is applied to the hardpoint of the wing via the load fixed to the hardpoint. In some embodiments, the stress relief area(s) 330 may be co-laminated into a top surface of the hardpoint relief pad 300 and may be constructed from the same material as the hardpoint relief pad 300, such as fiberglass. The top surface of the hardpoint relief pad 300 may be a surface of the hardpoint relief pad 300 that is not attached to the interior surface of the wing.

In some aspects, the stress relief area(s) 330 may be considered three-dimensional reliefs with profiles or shapes designed based on a load the hardpoint of the wing is designed to carry or support. As arranged in FIG. 3A, the first and the second stress relief areas 330A-B may be elongated along the longitudinal axis 300L. Within other examples, the stress relief area(s) 330 may be elongated along another axis such as the transverse axis 300T, or a combination of axes. The stress relief area(s) 330 may be elongated or shaped along a certain axis or combination of axes in order to deform or flex along a combination of axes. For example, the first stress relief area 330A may be elongated along or parallel to the longitudinal axis 300L such that the first stress relief area 330A may deform about the transverse axis 300T along the vertical axis 300V. In another aspect, when the first stress relief area 330A is elongated along or parallel to the longitudinal axis 300L, the first stress relief area 330A may be configured to deform in a direction perpendicular to the interior surface of the wing.

Within examples, the stress relief area(s) 330 may have a stiffness less than a stiffness of the adjacent areas of the hardpoint relief pad 300, and as such, the stress relief area(s) 330 may absorb some imposed strain and may relieve stress in an area around the hardpoint of the wing. For example, the stress relief area(s) may help distribute stresses imposed on the hardpoint by flexing and bending, and thus may help prevent failures around the hardpoint of the wing. The stiffness of the stress relief area(s) 330 may be based on the size and shape of the hollow cavity (such as the elongation along an axis) formed by the stress relief area(s) 330. The shape of the stress relief area(s) 330 may include a height or peak above the adjacent areas of the hardpoint relief pad 300. In at least one example, the stress relief area(s) 330 may taper out from the height above the adjacent area down to the top surface or possibly to edges of the hardpoint relief pad 300. In some aspects, the stress relief area(s) 330 may be able to survive more cyclical strain than the hardpoint area because the hardpoint area may be strain-limited by several factors, such as high stiffness, abrupt changes in stiffness, hole(s), bond fatigue, and/or fatigue limitations of insert materials.

As illustrated in FIG. 3A, the first stress relief area 330A may be located the distance d₁ away from a center of the hardpoint overlay 320 (or the hardpoint), and the distance d₁ may be along the transverse axis 300T. Similarly, the second stress relief area 330B may be located the distance d₂ away from the center of the hardpoint overlay 320 and the distance d₂ may also be along the transverse axis 300T. In one example, the first distance d₁ may be equal to the second distance d₂. In other implementations, the distances may differ to relieve strain for varying load profiles among other purposes. Within examples, the second stress relief area 330B may be elongated along the longitudinal axis 300L the distance d₃, or in other words the distance d₃ may be the length of the elongation of the hollow cavity of the second stress relief 330B. In some implementations, a ratio of the distance d₂ to the distance d₃ may be approximately 1:1. In other embodiments, the ratio of the distance d₂ to the distance d₃ may be different than 1:1 and may be based on expected loads that may be applied to the hardpoint. In at least one example, the distance d₂ and the distance d₃ may each be approximately 175-200 millimeters. The distances and the ratio of the distances may vary based on various features of the aerial vehicle (e.g., wing size, wing shape, internal wing structure, hardpoint location, hardpoint shape, etc.) and/or various anticipated or realized stresses.

Within examples, the first stress relief area 330A and the second stress relief area 330B may be symmetrically spaced about the hardpoint and/or the hardpoint overlay 320. In some embodiments with more than one of the stress relief area(s) 330, the stress relief area(s) 330 may be spaced symmetrically about one or more hardpoints. While the first and the second stress relief areas 330A-B are illustrated as elongated hollow cavities in FIG. 3A, the stress relief area(s) 330 may be constructed in a variety of geometries and may be used to relieve imposed strain on hardpoints and areas adjacent to the hardpoints. Within examples, the stress relief areas 330 may include multiple out-of-plane features. For example, in one embodiment, the stress relief area(s) 330 may include features similar to pleated bellows. In some examples, the stress relief area(s) 330 may include rises in elevation along an outer surface of the wing and/or along the interior surface of the wing. In some examples, the stress relief area(s) 330 may include a flange with a central hole.

While FIG. 3A illustrates the hardpoint relief pad 300 with the stress relief area(s) 330, other embodiments may include one or more of the stress relief area(s) 330 integrated into the interior surface of the wing. In such examples, the top surface of the hardpoint relief pad 300 may be considered an integrated part of the wing, such as the interior surface of the wing. For example, the first stress relief area 330A may be laminated into the interior surface of the wing the first distance di from the hardpoint. Further, the second stress relief area 330B may be laminated into the interior surface of the wing the second distance d₂ from the hardpoint. In some embodiments, the first stress relief area 330A and the second stress relief area 330B may be symmetrically spaced about the hardpoint of the wing. For example, the first distance di from the hardpoint and the second distance d₂ from the hardpoint may be the same,

Continuing with the figures, FIG. 3B illustrates cross-section view 3B-3B from FIG. 3A which depicts a cross section through the first stress relief area 330A. The view 3B-B of FIG. 3B may be from a perspective along the traverse axis 300T, according to some embodiments. As shown in FIG. 3B, the first stress relief area 330A protrudes above adjacent areas of the hardpoint relief pad 300 in a direction parallel to the vertical axis 300V. Further, the first stress relief area 330A may be elongated to form a hollow cavity 332 between the first stress relief area 330A and an interior surface 331 of the wing.

FIG. 3B also illustrates a base surface 310 of the hardpoint relief pad 300. Within examples, at least a portion of the base surface 310 may be configured to conform to and be fixedly attached to the interior surface 331 of the wing. For example, as shown in FIG. 3B, the base surface 310 may have a slight curvature that conforms to the shape of the interior surface 331 of the wing. In further embodiments, the base surface 310 may be adhered, or mechanically attached using another means. The base surface 310 may be a bottom side of the hardpoint relief pad 300 or a side that is opposite the top side of the hardpoint relief pad 300.

Similarly, FIG. 3C illustrates another cross-sectio view 3C-3C of the hardpoint relief pad 300 from FIG. 3A. The view 3C-3C shown in FIG. 3C may be from a perspective along the longitudinal axis 300L and may include the base surface 310, the first stress relief area 330A, the second stress relief area 330B, the hardpoint overlay 320 and the oculus 322 of the hardpoint relief pad 300. FIG. 3C also depicts a hardpoint 323 of the wing, the interior surface 331 of the wing, a first hollow cavity 332A, a second hollow cavity 332B, and adjacent areas 305. As shown in FIG. 3C, the first stress relief area 330A, the second stress relief area 330B and the hardpoint overlay 320 may each protrude above adjacent areas of the hardpoint relief pad 300. Within examples, the first stress relief area 330A, the second stress relief area 330B and the hardpoint overlay 320 may each protrude in a direction parallel to vertical axis 300V. The adjacent areas 305 include areas of the hardpoint relief pad between features of the hardpoint relief pad 300 (such as the stress relief area(s) 330 and the hardpoint overlay 323). Within examples, the adjacent areas 305 may include areas of the hardpoint relief pad 300 that are conformed to the interior surface 331 of the wing.

In some aspects, the hardpointoverlay 320 may be adapted to conform to the hardpoint 323 of the wing. The hardpoint 323 may be configured to carry a load and serve as an attachment location for external attachments to the wing of the aerial vehicle. In some examples, such attachments may include a pylon or tail boom. As shown in FIG. 3B, the hardpoint overlay 320 may have the same or similar shape as the hardpoint 323. Within examples, the hardpoint overlay 320 also includes the oculus 322 configured to allow a load (such as the pylon or tail boom) to be fixed to the hardpoint 323 through the hardpoint overlay 320. For example, a pylon, such as one of the pylons 133A-D of FIG. 1, may be attached to the wing through the interior surface 331 of the wing, the hardpoint 323 and the hardpoint overlay 320 by bolting the pylon through the oculus 322.

As illustrated in FIG. 3C, the base surface 310 may include multiple portions of the hardpoint relief pad 300 that conform to the interior surface 331 of the wing. For example, the base surface 310 may include the bottom surface of the hardpoint relief pad 300 between features of the hardpoint relief pad 300, such as between the stress relief area(s) 330 and the hardpoint overlay 320.

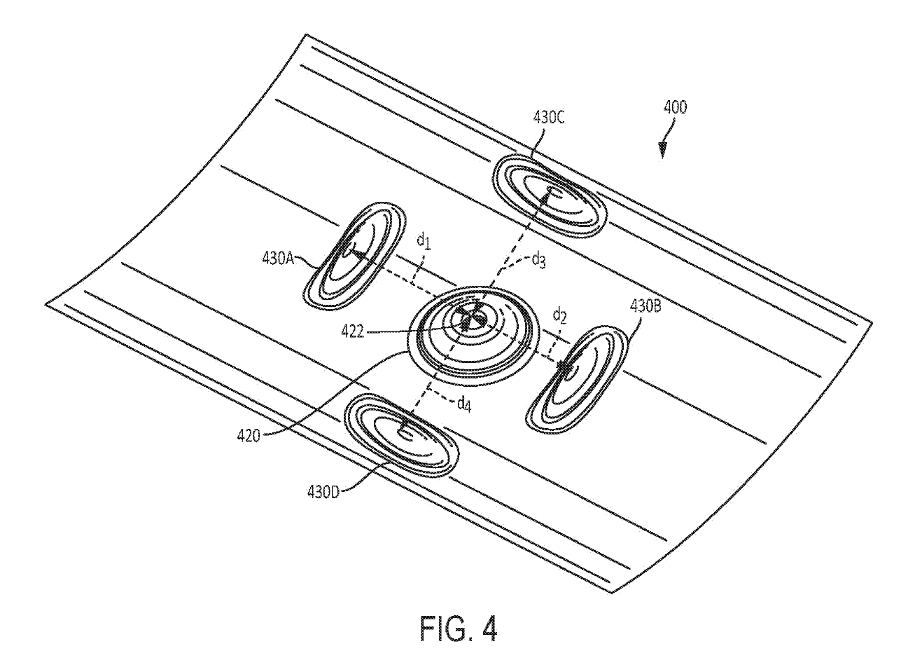

FIG. 4 illustrates a hardpoint relief pad 400 that includes a hardpoint overlay 420, an oculus 422, a first stress relief area 430A, a second stress relief area 430B, a third stress relief area 430C, a fourth stress relief area 430D (together, one or more stress relief area(s) 430), and distances d₁-d₄ (from one of the stress relief area(s) 430 to a center of the hardpoint overlay 420). Features of the hardpoint relief pad 400 may be the same or similar to corresponding features of the hardpoint relief pad 300.

FIG. 4 illustrates an arrangement of stress relief area(s) 430 spaced about the hardpoint overlay 420, the hardpoint overlay 420 adapted to conform to a hardpoint of the wing (not shown in this view). Similar to the stress relief area(s) 330 of FIG. 3A, the stress relief area(s) 430 may each form a hollow cavity, and each of the hollow cavities may be elongated along one or more axes. Within examples, the stress relief area(s) 430 may be configured in various ways to reduce strain. As such, the stress relief area(s) 430 may be configured to deform about one or more axes in order to reduce stresses about one or more axes. For example, the first and the second stress relief areas 430A-B may form hollow cavities elongated along a longitudinal axis (similar to the first and second stress relief areas 330A-B of FIG. 3A-3C), while the third and fourth stress relief areas 430C-D may form hollow cavities elongated along a transverse axis that may be perpendicular to the longitudinal axis. Then, for example, the first and the second stress relief areas 430A-B may be configured to deform or flex around the transverse axis (perpendicular to the elongation of the first and the second stress relief areas 430A-B) while the third and fourth stress relief areas 430C-D may be configured to deform or flex around the longitudinal axis (perpendicular to the elongation of the third and fourth stress relief areas 430C-D). In other embodiments, stress relief area(s) 430 may be configured along other axes to beneficially relieve load at a hardpoint, on a laminated surface near a hardpoint, or to mitigate stress concentrations at the edges of the stress relief area(s) 430.

As shown in FIG. 4, the stress relief area(s) may be symmetrically spaced about the hardpoint overlay 420. Within examples, the first, second, third and fourth stress relief areas 430A-D may each respectively be the distances d₁ through d₄ away from the center of the hardpoint overlay 420. In some examples, the distances d₁ through d₄ may each be the same, while in other examples they may be different. In other embodiments the distances d₁ and d₂ may be the same, but may different from distances d₃ through d₄ that may be the same. A variety of distances and ratios of such distances may be possible in order to best relieve stresses based on expected loading applied to the hardpoint of the wing.

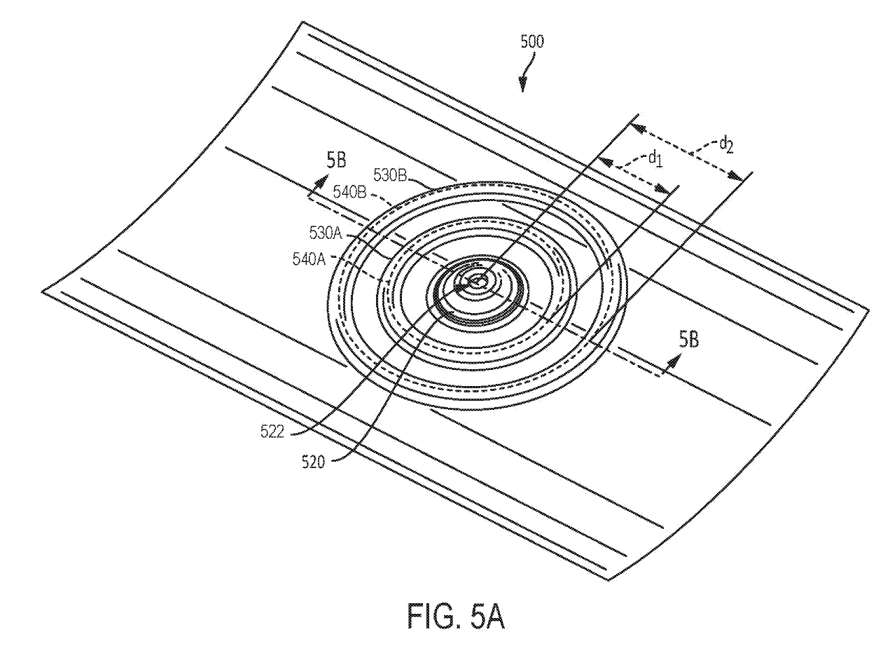

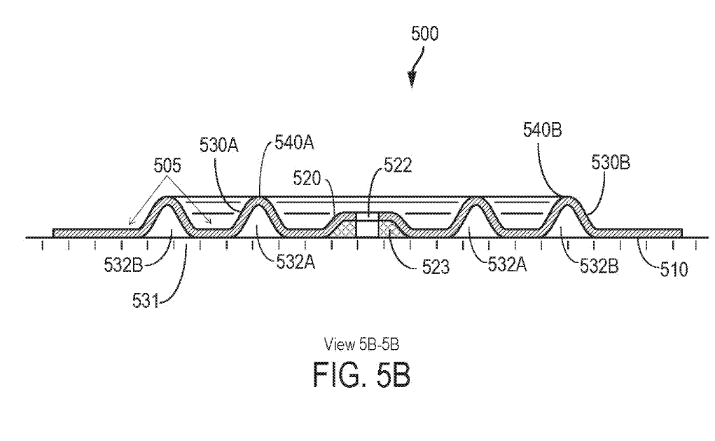

Continuing with the figures, FIG. 5A is a perspective view of a hardpoint relief pad 500, according to some embodiments. Elements of FIG. 5A may be the same or similar to elements described in reference to FIGS. 3-4. FIG. 5A includes the hardpoint relief pad 500, a hardpoint overlay 520, an oculus 522, a first stress relief area 530A with a center peak 540A that is a distance d₁ from a center of the hardpoint overlay 520, a second stress relief area 530B with a center peak 540B that is a distance d₂ from the center of the hardpoint overlay 520. Together, the first and the second stress relief areas 530A-B, may be referred to as the stress relief area(s) 530.

As illustrated in FIG. 5A, the stress relief area(s) 530 may be circular and form a hollow cavity(ies) that is circular in shape and may be centered about a hardpoint of the wing. Within examples, the stress relief area(s) 503 may be considered ripple reliefs and may lessen stresses with more even distributed loads, for example where in-plane loads may not be a primary concern. Similar to the stress relief areas described in FIGS. 3A and 4, the stress relief area(s) 530 may be configured to deform or flex in order to relieve stresses on the hardpoint, the laminated area surrounding the hardpoint, and/or the edges of the stress relief area(s) 530. In some embodiments, the circular stress relief area(s) 530 may be configured to surround or substantially surround a hardpoint of the wing.

The distances d₁ and d₂ between the center of the hardpoint overlay 520 and the center peaks 540A-B may vary based on the design conditions and loading of the hardpoint that corresponds to the hardpoint overlay 520. Within examples, there may be a ratio between the distances d₁ and d₂ based on the expected stresses applied to the hardpoint via a load such as a pylon or tail boom.

FIG. 5B illustrates a cross-section view 5B-5B from FIG. 5A. FIG. 5B further includes adjacent areas 505, a hardpoint 523 of the wing, an interior surface 531 of the wing, a first hollow cavity 532A and a second hollow cavity 532B. As shown in FIG. 5B, the stress relief area(s) 530 and the hardpoint overlay 520 may protrude above adjacent areas 505 of the hardpoint relief pad 500. The adjacent areas 505 may include areas of the hardpoint relief pad 500 that are between protruding features of the hardpoint relief pad 500, such as between the stress relief area(s) 530. Further, the adjacent areas 505 may include areas between stress relief areas 530 and edges of the hardpoint relief pad 500. Within examples the center peaks 540A-B may have a same elevation or height above the interior surface 531 of the wing, or may have differing elevations based on varying load profiles when a load is applied to the hardpoint 523.

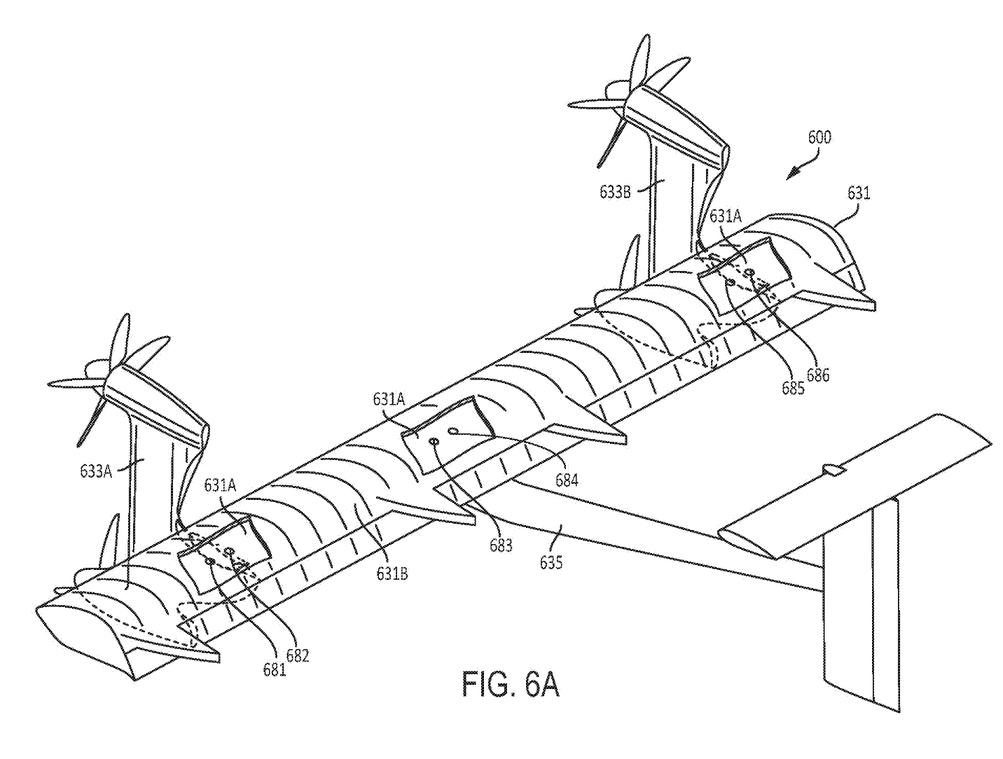

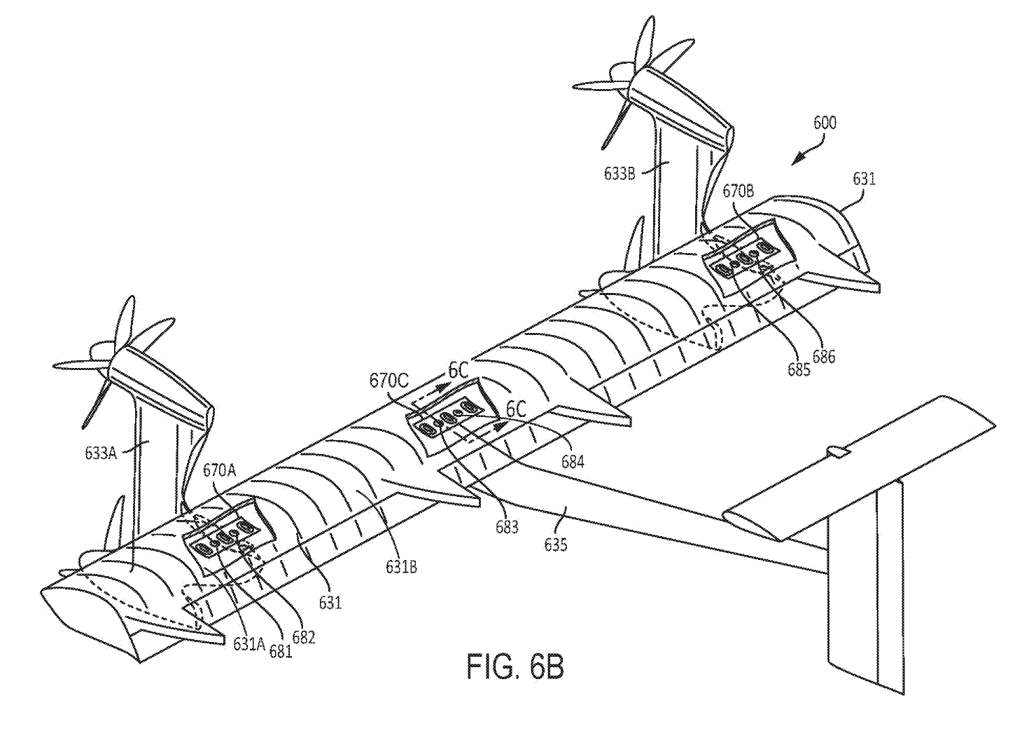

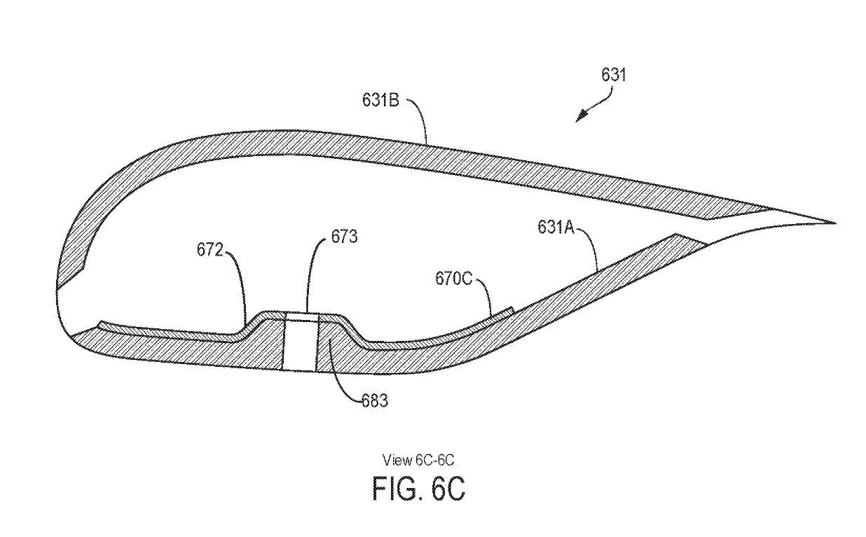

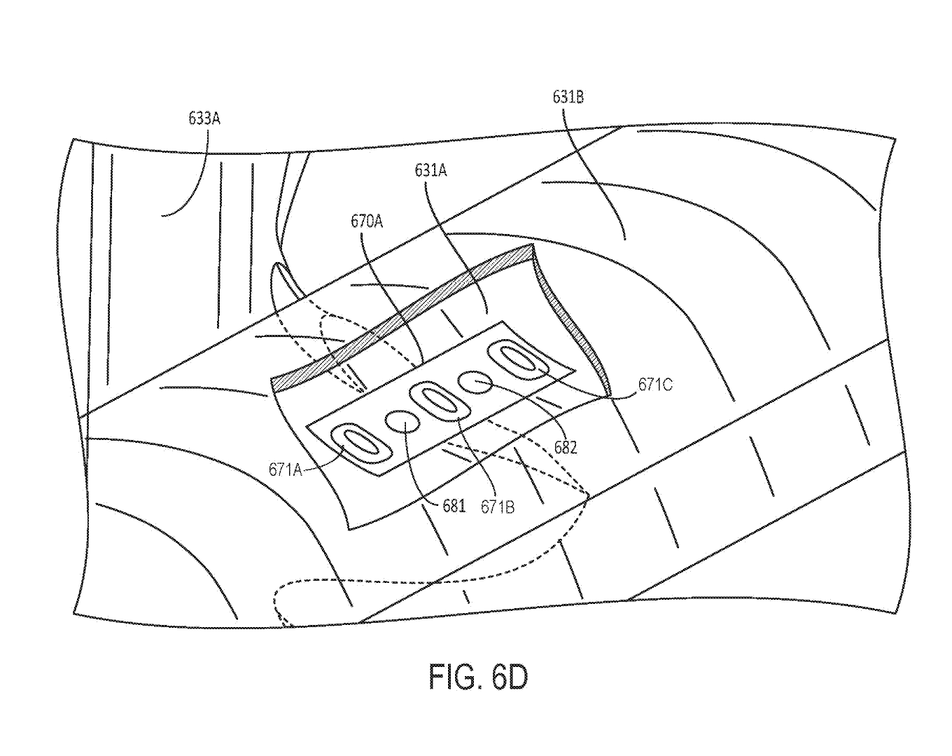

FIG. 6A is a perspective view of an aerial vehicle 600 illustrating bottom interior wing surface hardpoint locations, according to some embodiments. FIG. 6A includes the aerial vehicle 600, a wing 631 with an interior wing surface 631A and an exterior wing surface 631B, pylons 633A and 633B, a tail boom 635, and hardpoints 681, 682, 683, 684, 685, and 686. The wing 631 is depicted in FIG. 6A with three cutouts of exterior wing surface 631B cutout to show the six hardpoint locations (681, 682, 683, 684, 685, 686) along the bottom of the interior wing surface 631A. Hardpoints 681 and 682 may be configured to attach pylon 633A to the wing 631. Likewise, hardpoints 685 and 686 may be configured to attach pylon 633B to the wing 631. Finally, hardpoints 683 and 684 may be configured to attach the tail boom 635 to the wing 631. The hardpoints 681-686 may protrude from the interior surface 631A of the wing 631, similar to e hardpoints 323 and 523 of FIGS. 3C and 5B respectively.

FIG. 6B is another perspective view of the aerial vehicle 600 illustrating hardpoint relief pads 670A-C on the interior surface 631A of the wing 631. Similar to FIG. 6A, FIG. 6B illustrates the wing 631 with three cutouts from the exterior wing surface 631B in order to show the six hardpoints 681-686 and the corresponding hardpoint relief pads 670A-C on the interior surface 631A. The three hardpoint relief pads 670A-C may be configured to relieve stresses on the hardpoints 681-686 and areas surrounding the hardpoints 681-686, similar to the hardpoint relief pads 300, 400 and 500 of FIGS. 3A, 4 and 5A respectively.

FIG. 6C illustrates a cross-section view 6C-6C from FIG. 6B of the wing 631 of aerial vehicle 600. FIG. 6C includes the wing 631 with the interior surface 631A, the exterior surface 631B, the hardpoint relief pad 670C and the hardpoint 683. The hardpoint relief pad 670C includes a hardpoint overlay 672 and an oculus 673.

FIG. 6D is a zoomed-in perspective view of a portion of the wing 631 from FIG. 6B. Included in the view provided by FIG. 6D is the interior surface 631A and the exterior surface 631B of the wing 631, the pylon 633A, the hardpoint relief pad 670A, a first stress relief area 671A, a second stress relief area 671B, a third stress relief area 671C, hardpoint 681, and hardpoint 682. As shown in FIG. 6D, the hardpoint relief pad 670A may be similar and include features similar to the hardpoint relief pads 300, 400 and 500 of FIGS. 3A, 4 and 5A respectively.

FIG. 6D illustrates an embodiment where the load of the pylon 633A is attached to two hardpoints 681-682 and three stress relief areas 671A-C may be symmetrically spaced such that the stress relief areas 671A-C alternate such that each of the hardpoints 681-682 has stress relief on either side of the respective hardpoint 681-682 along a transverse axis. Within other examples, relief pads have other configurations or arrangements with varying number of hardpoints and/or stress relief areas.

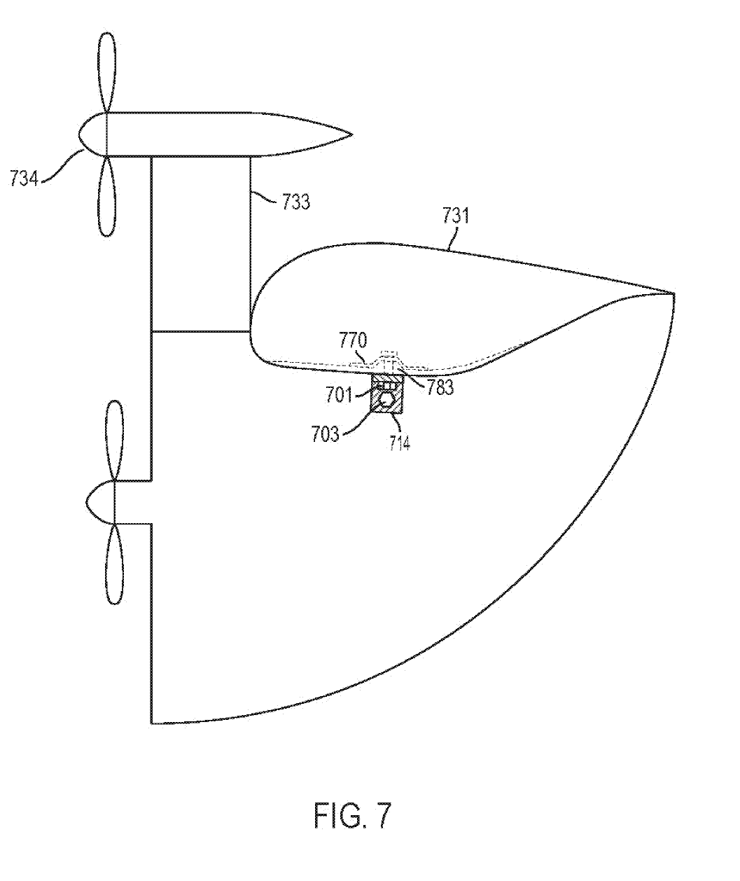

FIG. 7 illustrates an external view of a pylon 733 coupled to the wing 731. While the pylon 733 is attached to the wing in FIG. 7, other embodiments may include other and/or additional external attachments, such as a tail boom. FIG. 7 includes the wing 731, a bracket 714, a first fastener 701, a second fastener 703, a pylon 733, a hardpoint relief pad 770 and a hardpoint 783.

The hardpoint relief pad 770 and the hardpoint 783 may be within the interior of the wing 731 (as such, the hardpoint relief pad 770 and the hardpoint 783 are shown as dashed lines in FIG. 7). Further, the hardpoint relief pad 770 and hardpoint 783 may be similar the hardpoint relief pad 670 and hardpoint 683 of FIG. 6C.

The pylon 733 may be coupled to the wing 731 via the fasteners 701 and 703 and the bracket 714. Within examples, the bracket 714 may be fixedly attached to the pylon 733 by inserting fastener 703 through a hole of the bracket 714, through the exterior surface of the pylon 733 and into a receiver (not shown) of the pylon. The bracket 714 may be a 90 degree bracket, such that the first fastener 701 and the second fastener 703 are perpendicular to each other. The bracket 714 may be fixedly attached to the wing 731 by inserting the fastener 701 through a hole of the bracket, through the exterior surface of the wing 731, through the hardpoint 783 and through the hardpoint elief pad 770. The hardpoint relief pad 770 may include a hardpoint overlay and an oculus for the fastener 701 to fit through and attach to the hardpoint 783.

In some embodiments, the hardpoint relief pad 770 may also be integrated within the wing 731 to relieve strain at the hardpoint 783. In other embodiments, additional brackets, fasteners, and hardpoints may be used to secure the pylon 733 to the wing 731. The pylon 733 may support a propeller assembly or rotor assembly 734 as shown in FIG. 7, which may be similar to rotors 134A-D in FIG. 1.

### IV. Conclusion

It should be understood that arrangements described herein are for purposes of example only. As such, those skilled in the art will appreciate that other arrangements and other elements (e.g. machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. It is also to be understood that the terminology used herein is for the purpose of describing particular implementations only, and is not intended to be limiting.

What is claimed is:

1. A hardpoint relief pad comprising:
a base surface, wherein at least a portion of the base surface is configured to conform to and be fixedly attached to an interior surface of an aerial vehicle wing;
a hardpoint overlay protruding above adjacent areas of the hardpoint relief pad and adapted to conform to a hardpoint protruding from the interior surface of the wing, wherein the hardpoint is configured to carry a load fixed to the hardpoint, further wherein the hardpoint overlay comprises an oculus configured to allow the load to be fixed to the hardpoint through the hardpoint overlay; and
a first stress relief area protruding above adjacent areas of the hardpoint relief pad and forming a hollow cavity between the first stress relief area and the interior surface of the wing, wherein the first stress relief area is configured to deform in one or more axes when stress is applied to the hardpoint via the load.

2. The hardpoint relief pad of claim 1, further comprising:
a second stress relief area protruding above adjacent areas of the hardpoint relief pad and forming another hollow cavity between the second stress relief area and the interior surface of the wing.

3. The hardpoint relief pad of claim 2, wherein the first stress relief area and the second stress relief area are symmetrically spaced about the hardpoint.

4. The hardpoint relief pad of claim 1, wherein the first stress relief area is elongated along a longitudinal axis.

5. The hardpoint relief pad of claim 1, wherein the first stress relief area is elongated along a longitudinal axis a first distance and is located a second distance from the hardpoint overlay, wherein the first distance is the same as the second distance.

6. The hardpoint relief pad of claim 1, wherein the first stress relief area is circular and centered on the hardpoint.

7. The hardpoint relief pad of claim 2, wherein the first and the second stress relief areas are circular and concentric about the hardpoint.

8. The hardpoint relief pad of claim 1, wherein the first stress relief area is configured to deform along at least one of a longitudinal axis, a transverse axis, and a vertical axis.

9. The hardpoint relief pad of claim 1, further comprising:
a second hardpoint overlay protruding above adjacent areas of the hardpoint relief pad and adapted to conform to a second hardpoint protruding from the interior surface of the wing, wherein the second hardpoint is also configured to carry the load, further wherein the second hardpoint overlay comprises an oculus configured to allow the load to be fixed to the second hardpoint through the second hardpoint overlay.

10. The hardpoint relief pad of claim 9, further comprising:
at least two additional stress relief areas protruding above adjacent areas of the hardpoint relief pad and forming hollow cavities between the at least two additional stress relief areas and the interior surface of the wing, wherein the first stress relief area and the at least two additional stress relief areas are spaced symmetrically about the first and the second hardpoints.

11. The hardpoint relief pad of claim 1, wherein the load fixed to the hardpoint comprises a load from a pylon or a tail boom.

12. An aerial vehicle wing comprising:
a hardpoint protruding from an interior surface of the aerial vehicle wing, wherein the hardpoint is configured to carry a load fixed to the hardpoint; and
a first stress relief area integrated into the interior surface of the wing a first distance from the hardpoint, wherein the first stress relief area protrudes above adjacent areas of the interior surface of the wing forming a hollow cavity within the interior surface of the wing.

13. The aerial vehicle wing of claim 12, wherein the first stress relief area is laminated into the interior surface of the wing.

14. The aerial vehicle wing of claim 12, wherein the load fixed to the hardpoint comprises a load from a pylon or a tail boom.

15. The aerial vehicle wing of claim 12, further comprising:
a second stress relief area integrated into the interior surface of the wing a second distance from the hardpoint, wherein the second stress relief area protrudes above adjacent areas of the interior surface of the wing forming another hollow cavity between the second stress relief area and the interior surface of the wing.

16. The aerial vehicle wing of claim 15, wherein the first distance and the second distance are the same.

17. The aerial vehicle wing of claim 12, wherein the first stress relief area is elongated along a longitudinal axis.

18. The aerial vehicle wing of claim 12, wherein the first stress relief area is circular and centered on the hardpoint.

19. The aerial vehicle wing of claim 12, wherein the first stress relief area is configured to deform along at least one of a longitudinal axis, a transverse axis, and a vertical axis when stress is applied via the load.

20. An aerial vehicle comprising:
a pylon fixedly attached to a first hardpoint that protrudes from an interior surface of a wing of the aerial vehicle;
a tail boom fixedly attached to a second hardpoint that protrudes from the interior surface of the wing;
a first hardpoint relief pad corresponding to the first hardpoint; and
a second hardpoint relief pad corresponding to the second hardpoint, wherein each the first and the second hardpoint relief pad comprises:
a base surface, wherein at least a portion of the base surface is configured to conform to and be fixedly attached to the interior surface of the wing;
a hardpoint overlay protruding above adjacent areas of the hardpoint relief pad and adapted to conform to at least one of the first and the second hardpoints, wherein the hardpoint overlay comprises an oculus configured to allow the pylon or the tail boom to be fixed to the first or the second hardpoint through the hardpoint overlay;
a first stress relief area protruding above adjacent areas of the hardpoint relief pad and forming a hollow cavity between the first stress relief area and the interior surface of the wing, wherein the hardpoint relief pad is configured to deform in one or more axes when stress is applied to the first or the second hardpoint via the pylon or the tail boom.
